(19) United States
(12) Patent Application Publication
(10) Pub. No.: US 2013/0057523 A1
(43) Pub. Date: Mar. 7, 2013

(54) DISPLAY PANEL AND DISPLAY

(71) Applicant: Keisuke Omoto, Kanagawa (JP)

(72) Inventor: Keisuke Omoto, Kanagawa (JP)

(73) Assignee: SONY CORPORATION, Tokyo (JP)

(21) Appl. No.: 13/597,368

(22) Filed: Aug. 29, 2012

(30) Foreign Application Priority Data
Sep. 7, 2011 (JP) 2011-194958

(51) Int. Cl. G09G 3/30; G06F 3/038

(52) U.S. Cl. 345/204; 345/76

(57) ABSTRACT

A display panel includes, for each pixel, an organic EL device and a pixel circuit. The pixel circuit has a first transistor to write an image signal and a second transistor to drive the organic EL device based on the image signal written by the first transistor, the second transistor having a gate, a source, and a drain. The organic EL device has an anode, an organic layer, and a cathode. The gate of the second transistor is a simple structure of a transparent conductive layer, or a stacked structure of a transparent conductive layer and a metallic conductive layer. The anode of the organic EL device has a layer that is formed on a same layer as the transparent conductive layer and is formed of a same material as the transparent conductive layer.

### BACKGROUND

The present technology relates to a display panel including an organic EL (Electro Luminescence) device, and a display including such a display panel.

In recent years, in the field of a display for performing an image display, a display using a current drive type optical device the luminescence of which varies depending on a value of a flowing current, such as an organic EL device as a pixel light-emitting device has been developed and the commercialization thereof has been advanced (for example, see Japanese Unexamined Patent Application Publication No. 2011-23240).

Unlike a liquid crystal device and the like, an organic EL device is a self-emitting device. Therefore, a display using the organic EL device (organic EL display) eliminates the need for a light source (backlight), achieving higher image visibility, lower power consumption, and higher device response speed as compared with a liquid crystal display involving a light source.

As with a liquid crystal display, an organic EL display has a simple (passive) matrix method and an active matrix method as a drive method thereof. The former is disadvantageous in that it is difficult to achieve a large-sized and high-definition display in spite of a simple structure. Consequently, at present, the active matrix method has been actively developed. This method controls a current flowing through a light-emitting device arranged for each pixel using an active device (typically a TFT (Thin Film Transistor)) provided within a driving circuit prepared for each light-emitting device.

FIG. 18 shows a cross-sectional structure of a typical sub-pixel in an organic EL display. A sub-pixel 100 illustrated in FIG. 18, which is a bottom-emission structure sub-pixel, includes, for example, a planarizing layer 120 on a circuit substrate 110 where a pixel circuit such as a TFT is formed thereon, and has an organic EL device 130 on the planarizing layer 120. The organic EL device 130 has, for example, an anode electrode 131, an organic layer 132, and a cathode electrode 133 in this order from the planarizing layer 120 side. A stacked portion at the organic layer 132 and the cathode electrode 133 on the anode electrode 131 is defined by an opening formed on a window-defining layer 140.

### SUMMARY

Meanwhile, the sub-pixel illustrated in FIG. 18 involves a great number of processes after formation of the circuit substrate 110. This causes a disadvantage of the increase in the manufacturing cost.

It is desirable to provide a display panel that ensures to reduce a number of processes after formation of a circuit substrate, and a display including such a display panel.

According to an embodiment of the present disclosure, there is provided a display panel including, for each pixel, an organic EL device and a pixel circuit. The pixel circuit has a first transistor to write an image signal and a second transistor to drive the organic EL device based on the image signal written by the first transistor, the second transistor having a gate, a source, and a drain. The organic EL device has an anode, an organic layer, and a cathode. The gate of the second transistor is a simple structure of a transparent conductive layer, or a stacked structure of a transparent conductive layer and a metallic conductive layer. The anode of the organic EL device has a layer that is formed on a same layer as the transparent conductive layer and is formed of a same material as the transparent conductive layer.

According to an embodiment of the present disclosure, there is provided a display including: a display panel; and a driving circuit driving each pixel. The display panel has an organic EL device and a pixel circuit for each pixel. The pixel circuit has a first transistor to write an image signal and a second transistor to drive the organic EL device based on the image signal written by the first transistor, the second transistor having a gate, a source, and a drain. The organic EL device has an anode, an organic layer, and a cathode. The gate of the second transistor is a simple structure of a transparent conductive layer, or a stacked structure of a transparent conductive layer and a metallic conductive layer. The anode of the organic EL device has a layer that is formed on a same layer as the transparent conductive layer and is formed of a same material as the transparent conductive layer.

In the light-emitting panel and the display according to the embodiments of the present disclosure, on the anode of the organic EL device, there is provided the layer that is formed on the same layer as the transparent conductive layer of the gate and is formed of the same material as the transparent conductive layer. For example, this allows an anode electrode to be fabricated on a substrate where the gate is formed thereon, further allowing the anode electrode to be formed along with the gate collectively.

The display panel and the display according to the embodiments of the present disclosure allow the anode electrode to be formed on the substrate where the gate is formed thereon, further allowing the anode electrode to be formed along with the gate collectively, which makes it possible to omit steps to form a planarizing layer or separately form the anode electrode. Therefore, it is possible to reduce a number of processes after formation of a circuit substrate.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a schematic block diagram of a display according to an embodiment of the present technology.

FIG. 2 is a diagram showing an example of a circuit configuration of a sub-pixel illustrated in FIG. 1.

FIG. 3 is a diagram showing an example of a cross-sectional structure of the sub-pixel illustrated in FIG. 1.

FIG. 4 is a diagram for explaining an example of a method of manufacturing the sub-pixel illustrated in FIG. 3.

FIG. 5 is a diagram for explaining a process following the process of FIG. 4.

FIG. 6 is a diagram for explaining a process following the process of FIG. 5.

FIG. 7 is a diagram for explaining a process following the process of FIG. 6.

FIG. 8 is a diagram for explaining a process following the process of FIG. 7.

FIG. 9 is a diagram for explaining a process following the process of FIG. 8.

FIG. 10 is a diagram for explaining a process following the process of FIG. 9.

FIG. 11 is a diagram showing a modification example of the sub-pixel illustrated in FIG. 3.

FIG. 12 is a plan view showing a schematic structure of a module including the display according to the above-described embodiment of the present technology.

FIG. 13 is a perspective view showing an external appearance of an application example 1 of the display according to the above-described embodiment of the present technology.

FIG. 14A is a perspective view showing an external appearance of an application example 2 that is viewed from the front side thereof, while FIG. 14B is a perspective view showing an external appearance that is viewed from the rear side.

FIG. 15 is a perspective view showing an external appearance of an application example 3.

FIG. 16 is a perspective view showing an external appearance of an application example 4.

FIG. 17A is a front view of an application example 5 in an open state, FIG. 17B is a side view thereof, FIG. 17C is a front view in a closed state, FIG. 17D is a left-side view, FIG. 17E is a right-side view, FIG. 17F is a top view, and FIG. 17G is a bottom view.

FIG. 18 is a diagram showing an example of a circuit configuration of an existing sub-pixel.

### DETAILED DESCRIPTION

Hereinafter, the embodiments of the present disclosure are described in details with reference to the drawings. It is to be noted that the descriptions are provided in the order given below.

1. Embodiment

2. Modification Example

3. Module and Application Examples

### 1. Embodiment

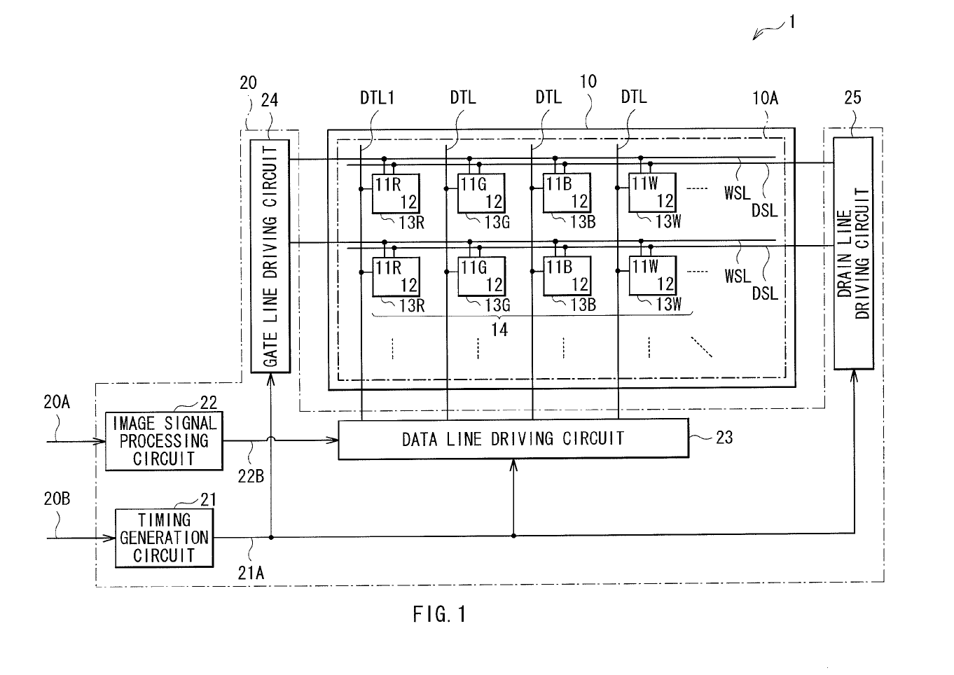

FIG. 1 shows an example of an overall configuration of a display 1 according to an embodiment of the present technology. The display 1 includes a display panel 10 and a driving circuit 20 driving the display panel 10.

The display panel 10 has a display region 10A where a plurality of display pixels 14 are arranged two-dimensionally. The display panel 10 displays an image based on an image signal 20A that is input externally, through an active matrix driving of each of the display pixels 14. Each of the display pixels 14 includes multiple types of sub-pixels with emitted colors different from each other. In concrete terms, each of the display pixels 14 includes a red sub-pixel 13R, a green sub-pixel 13G, a blue sub-pixel 13B, and a white sub-pixel 13W. It is to be noted that the sub-pixels 13R, 13G, 13B, and 13W are hereinafter collectively referred to as a sub-pixel 13.

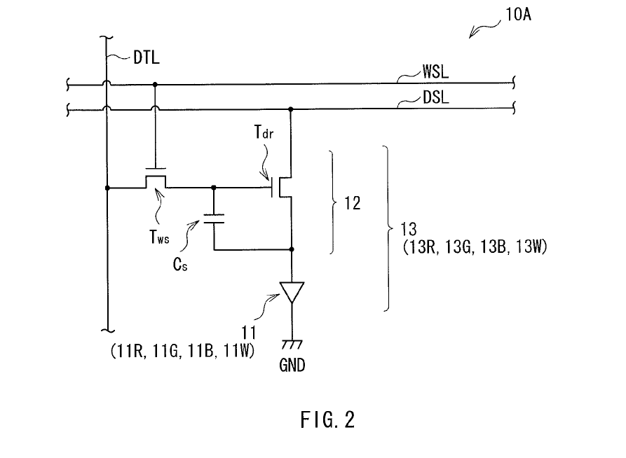

FIG. 2 shows an example of a circuit configuration of the sub-pixel 13. As shown in FIG. 2, the sub-pixel 13 has an organic EL device 11 and a pixel circuit 12 driving the organic EL device 11. It is to be noted that the sub-pixel 13R is provided with an organic EL device 11R emitting red EL light as the organic EL device 11. Similarly, the sub-pixel 13G is provided with an organic EL device 11G emitting green EL light as the organic EL device 11. The sub-pixel 13B is provided with an organic EL device 11B emitting blue EL light as the organic EL device 11. The sub-pixel 13W is provided with an organic EL device 11W emitting white EL light as the organic EL device 11.

The pixel circuit 12 is configured to include, for example, a writing transistor Tws (first transistor), a driving transistor Tdr (second transistor), and a holding capacitor Cs, employing a circuit configuration of 2TrlC. It is to be noted that the pixel circuit 12 is not limited to such a circuit configuration of 2TrlC, but may have two writing transistors Tws that are connected in series with each other, or may include any transistor and capacitor other than those above.

The writing transistor Tws is a transistor that writes a voltage corresponding to the image signal 20A into the holding capacitor Cs. The driving transistor Tdr is a transistor that drives the organic EL device 11 based on a voltage written into the holding capacitor Cs by the writing transistor Tws. The writing transistor Tws and the driving transistor Tdr are composed of, for example, n-channel MOS TFTs (Thin Film Transistors). It is to be noted that the writing transistor Tws and the driving transistor Tdr may be composed of p-channel MOS TFTs alternatively.

The driving circuit 20 has a timing generation circuit 21, an image signal processing circuit 22, a data line driving circuit 23, a gate line driving circuit 24, and a drain line driving circuit 25. The driving circuit 20 also has data lines DTL connected with an output of the data line driving circuit 23, gate lines WSL connected with an output of the gate line driving circuit 24, and drain lines DSL connected with an output of the drain line driving circuit 25. Further, the driving circuit 20 has a ground line GND (see FIG. 2) connected with a cathode of the organic EL device 11. It is to be noted that the ground line GND is intended to be connected with a ground, and becomes a ground voltage when connected with a ground.

The timing generation circuit 21 controls, for example, the data line driving circuit 23, the gate line driving circuit 24, and the drain line driving circuit 25 to operate in conjunction with one another. For example, the timing generation circuit 21 outputs a control signal 21A to these circuits depending on a synchronization signal 20B that is input externally (in synchronization with such a signal).

The image signal processing circuit 22, for example, corrects the digital image signal 20A that is input externally, and converts the corrected image signal into an analog signal, delivering a resulting signal voltage 22B to the data line driving circuit 23 as an output.

The data line driving circuit 23 writes the analog signal voltage 22B that is input from the image signal processing circuit 22 into the display pixel 14 (or the sub-pixel 13) to be selected via each data line DTL in response to an input of the control signal 21A (in synchronization with this signal). The data line driving circuit 23, for example, is capable of outputting the signal voltage 22B and a constant voltage independent of the image signal.

The gate line driving circuit 24 sequentially applies selection pulses to the plurality of gate lines WSL in response to an input of the control signal 21A (in synchronization with this signal), thereby sequentially selecting the plurality of display pixels 14 (or the sub-pixel 13) in a unit of the gate line WSL. The gate line driving circuit 24, for example, is capable of outputting a voltage to be applied in turning on the writing transistor Tws, and a voltage to be applied in turning off the writing transistor Tws.

The drain line driving circuit 25 outputs a predetermined voltage to a drain of the driving transistor Tdr in each pixel circuit 12 via each drain line DSL in response to an input of the control signal 21A (in synchronization with this signal). The drain line driving circuit 25, for example, is capable of outputting a voltage to be applied in putting the organic EL device 11 in a light-emission state, and a voltage to be applied in putting the organic EL device 11 in a light-extinction state.

Next, the connection relationship and arrangement of components are described with reference to FIG. 2. The gate line WSL is formed to extend along a row direction, and is connected with a gate of the writing transistor Tws. The drain line DSL is also formed to extend along a row direction, and is connected with a drain of the driving transistor Tdr. The data line DTL is formed to extend along a column direction, and is connected with a drain of the writing transistor Tws.

A source of the writing transistor Tws is connected with a gate of the driving transistor Tdr and a first end of the holding capacitor Cs. A source of the driving transistor Tdr and a second end (a terminal unconnected with the writing transistor Tws) of the holding capacitor Cs are connected with an anode of the organic EL device 11. A cathode of the organic EL device 11 is connected with the ground line GND. For example, the cathode is formed over a whole area of the display region 10A.

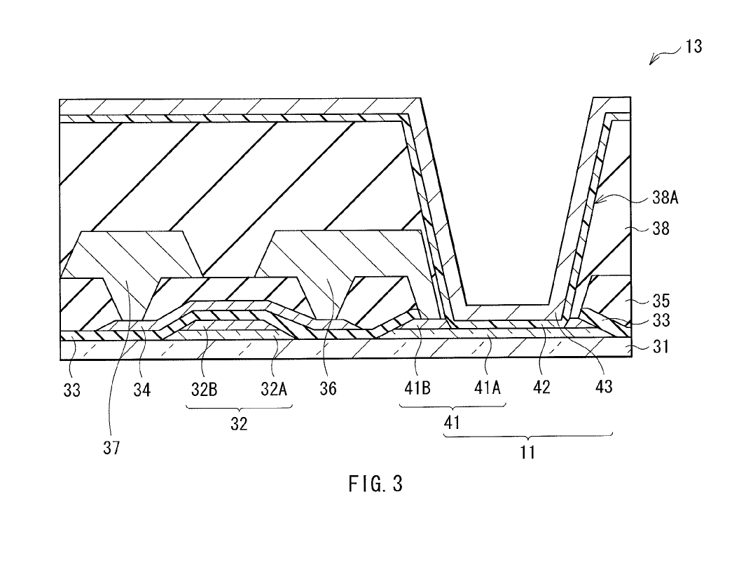

Subsequently, a cross-sectional structure at the display region 10A on the display panel 10 is described with reference to FIG. 3. As shown in FIG. 3 for example, the display panel 10 has a gate electrode 32, a gate insulating film 33, a channel layer 34, an insulating protective layer 35, a source electrode 36, a drain electrode 37, an opening-defining insulating layer 38, and the organic EL device 11 on a glass substrate 31.

Being formed on the front surface of the glass substrate 31, the gate electrode 32 is, for example, a stacked structure composed of a transparent conductive layer 32A and a metallic conductive layer 32B that are stacked in this order from the glass substrate 31 side. The gate insulating film 33 covers an almost whole area of the front surface of the glass substrate 31 including the gate electrode 32.

Being formed to get across a region in opposition to the gate electrode 32, the channel layer 34 is formed to extend in an opposite direction (to be hereinafter described) of the source electrode 36 and the drain electrode 37. A gap space between the source electrode 36 and the drain electrode 37 on the top surface of the channel layer 34 is an exposed surface that is not covered by the source electrode 36 and the drain electrode 37. A predetermined region including the exposed surface on the channel layer 34 is a channel region.

The source electrode 36 and the drain electrode 37 are disposed oppositely with a predetermined gap space in between in an in-plane direction of the channel layer 34. The source electrode 36 comes in contact with a first end of the channel layer 34 as well as an anode electrode 41 of the organic EL device 11. On the other hand, the drain electrode 37 comes in contact with a second end of the channel layer 34 as well as the drain line DSL. The insulating protective film 35 covers a whole area of the front surfaces of the gate insulating film 33 and the channel layer 34. The opening-defining insulating layer 38 has an opening 38A corresponding to a position of the organic EL device 11.

The organic EL device 11 has, for example, a structure in which the anode electrode 41, an organic layer 42, and a cathode electrode 43 are stacked in this order from the glass substrate 31 side. The organic layer 42 has, for example, a stacked structure in which a hole injection layer enhancing the hole injection efficiency, a hole transport layer enhancing the hole transport efficiency to a light-emitting layer, the light-emitting layer emitting light based on the electron-hole recombination, and an electron transport layer enhancing the electron transport efficiency to the light-emitting layer are stacked in this order from the anode electrode 41 side. The anode electrode 41 is formed on the front surface (planarized surface) of the glass substrate 31. Therefore, the anode electrode 41 is a planarized film following the planarized surface of the glass substrate 31. The organic layer 42 and the cathode electrode 43, which are formed at least in contact with the top surface of the anode electrode 41 that is the bottom surface of the opening 38A, cover a whole area of the bottom surface of the opening 38A and the front surface of the opening-defining insulating layer 38 for example.

The anode electrode 41 is, for example, a stacked structure composed of a transparent conductive layer 41A and a metallic conductive layer 41B that are stacked in this order from the glass substrate 31 side. The transparent conductive layer 41A, which is formed on the same layer as the transparent conductive layer 32A, is formed of the same material with the same film thickness as the transparent conductive layer 32A. The metallic conductive layer 41B, which is formed on the same layer as the metallic conductive layer 32B, is formed of the same material with the same film thickness as the metallic conductive layer 32B.

Next, the description is provided on an example of a method of manufacturing a thin film transistor 1 according to an embodiment of the present disclosure.

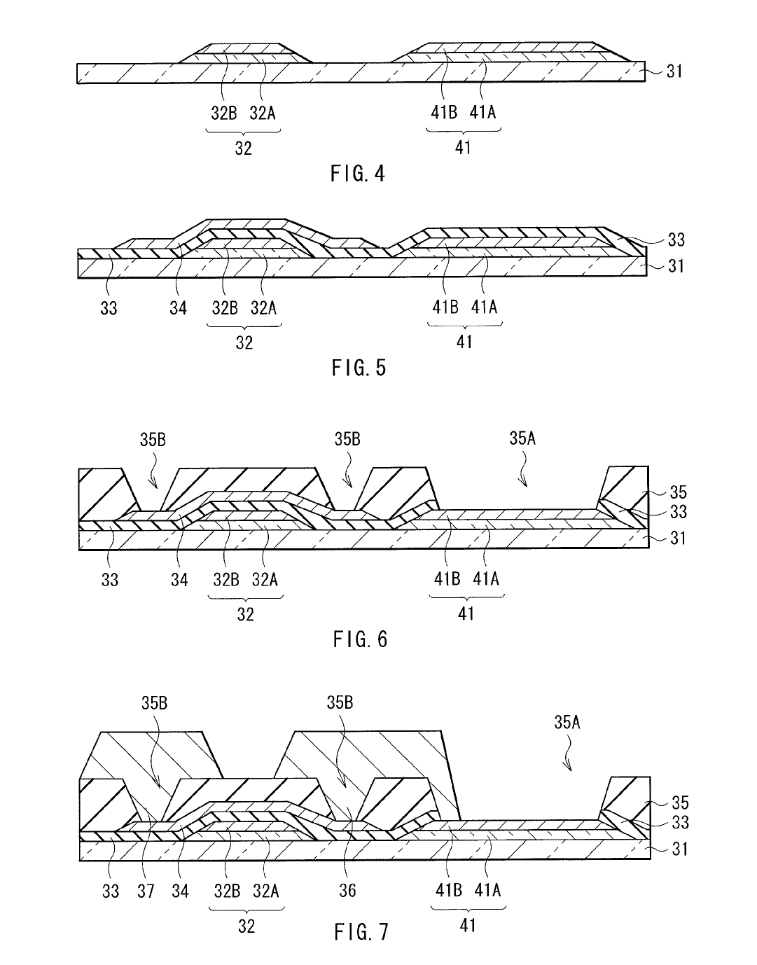

First, on a glass substrate 41, the gate electrode 32 is formed, and the anode electrode 41 is formed at the same time (FIG. 4). Subsequently, the gate insulating film 33 is formed over a whole area of the front surface including the gate electrode 32 and the anode electrode 41, and then the channel layer 34 is formed directly above the gate electrode 32 (FIG. 5). Afterward, the insulating protective layer 35 having openings 35A and 35B is formed. The opening 35A is formed directly above the anode electrode 41, and the openings 35B are formed directly above both ends of the channel layer 34 (FIG. 6). At this time, a portion just above the anode electrode 41 on the gate insulating film 33 is removed by etching through the opening 35A (FIG. 6).

Subsequently, materials to be used for the source electrode 36 and the drain electrode 37 are deposited as a film over a whole area of the front surface followed by patterning and etching, thereby forming the source electrode 36 and the drain electrode 37 at locations corresponding to the openings 35B (FIG. 7). At this time, the source electrode 36 is formed in such a manner that a part of the source electrode 36 comes in contact with the anode electrode 41 exposed to the bottom of the opening 35A.

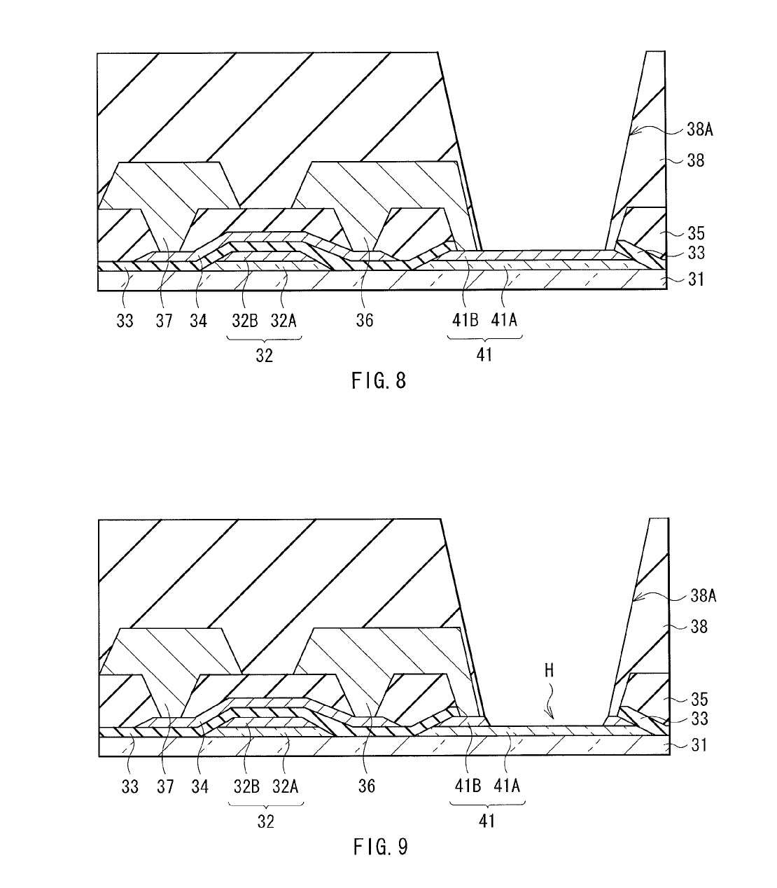

Thereafter, the opening-defining insulating layer 38 having the opening 3 8A corresponding to the opening 35A is formed (FIG. 8), and then the metallic conductive layer 41B exposed to the bottom of the opening 38A is removed by etching through the opening 38A (FIG. 9). This forms an opening H on the metallic conductive layer 41B corresponding to the bottom of the opening 38A, resulting in the transparent conductive layer 41A being exposed within the opening H (opening 38A). Subsequently, the organic layer 42 is formed to come in contact with the transparent conductive layer 41A exposed to the bottom of the opening 38A, and the cathode electrode 43 is formed on the organic layer 42. In such a manner, the organic EL device 11 is formed within the opening 38A. In a method described above, the sub-pixel 13 according to this embodiment is formed.

### [Operation and Effects]

In the display 1 according to the embodiment, the pixel circuit 12 is under on/off control in each display pixel 14, and a drive current is injected into the organic EL device 11 in each display pixel 14, thereby recombining hole and electron to emit light. This light is transmitted through the anode electrode 41 and the glass substrate 31 to be extracted to the outside. As a result, an image is displayed at the display region 10A.

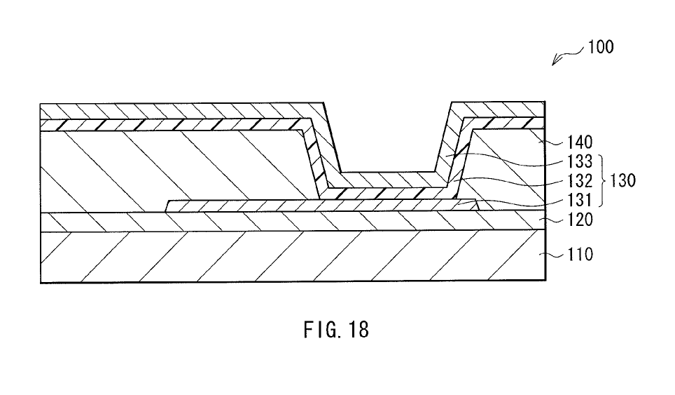

FIG. 18 shows a cross-sectional structure of a typical sub-pixel in an organic EL display. A sub-pixel 100 illustrated in FIG. 18, which is a bottom-emission structure sub-pixel, includes, for example, a planarizing layer 120 on a circuit substrate 110 where a pixel circuit such as a TFT is formed thereon, and has an organic EL device 130 on the planarizing layer 120. The organic EL device 130 has, for example, an anode electrode 131, an organic layer 132, and a cathode electrode 133 in this order from the planarizing layer 120 side. A stacked portion at the organic layer 132 and the cathode electrode 133 on the anode electrode 131 is defined by an opening formed on a window-defining layer 140.

Meanwhile, the sub-pixel illustrated in FIG. 18 involves a great number of processes after formation of the circuit substrate 110. This causes a disadvantage of the increase in the manufacturing cost.

On the contrary, in the embodiment of the present disclosure, on the anode electrode 41 of the organic EL device 11, there is provided a layer (transparent conductive layer 41A) that is formed on the same layer as the transparent conductive layer 32A on the gate electrode 32 of the driving transistor Tdr and is formed of the same material as the transparent conductive layer 32A. For example, this allows the anode electrode 41 to be formed on the glass substrate 31 where the gate electrode 32 is formed thereon, further allowing the anode electrode 41 to be formed along with the gate electrode 32 collectively, which makes it possible to omit steps of forming the planarizing layer 120 in FIG. 18 or separately forming the anode electrode 131 in FIG. 18. Therefore, it is possible to reduce a number of processes after formation of a circuit substrate.

### 2. Modification Example

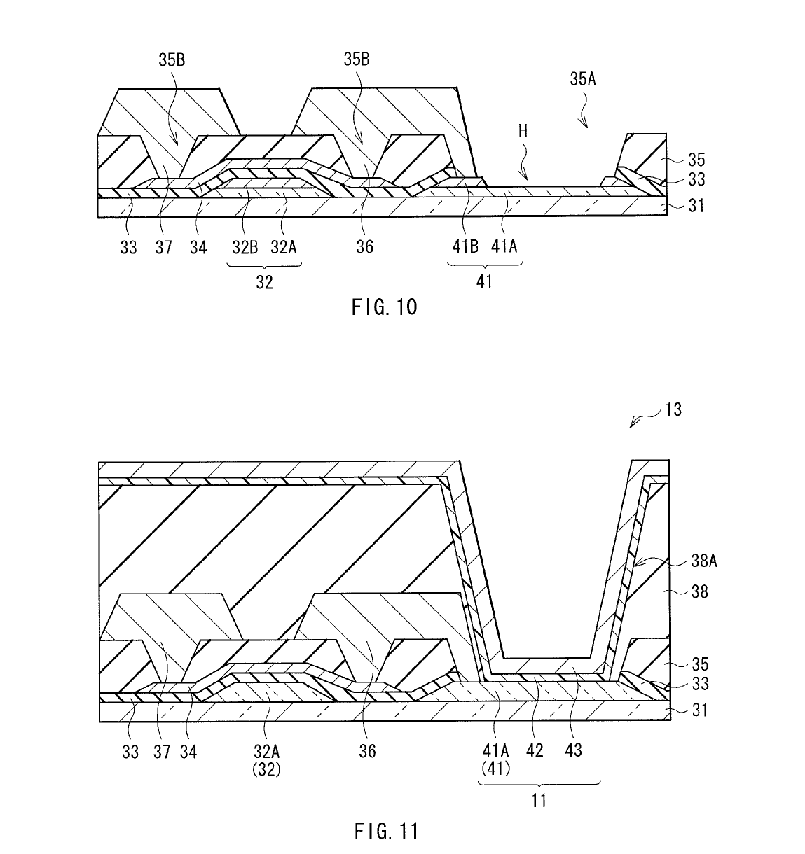

In a manufacturing process according to the above-described embodiment of the present disclosure, the opening H on the metallic conductive layer 41B is formed after formation of the opening-defining insulating layer 38, although this may be performed in a separate process alternatively. As shown in FIG. 10 for example, when the insulating protective layer 35 is formed, the opening H may be formed on the metallic conductive layer 41B by etching through the opening 35A.

Further, in the above-described embodiment of the present disclosure, both the gate electrode 32 and the anode electrode 41 are stacked structures, although they may be single-layered. As shown in FIG. 11 for example, the gate electrode 32 may be composed of a simple structure only of the transparent conductive layer 32A, and the anode electrode 41 may be also composed of a simple structure only of the transparent conductive layer 41A.

### 3. Module and Application Examples

Hereinafter, the description is provided on application examples of the display described in the above-described embodiment and the modification example thereof. The display according to the above-described embodiment and the like is applicable to displays on electronic units in various fields that display externally input image signals or internally generated image signals as images or pictures, such as television receivers, digital cameras, notebook personal computers, mobile terminals such as cellular phones, or video cameras.

### [Module]

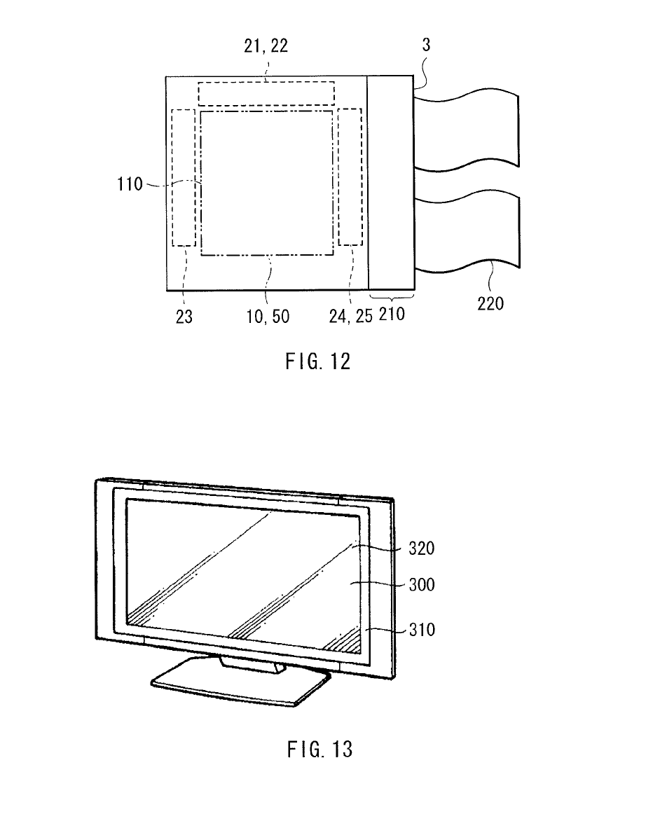

The display according to the above-described embodiment and the like is built into various electronic units in application examples 1 to 5 to be hereinafter described, as a module shown in FIG. 12 for example. For example, this module has a region 210 exposed from a member (not shown in the figure) sealing a display section 10 at one side of a substrate 3, and wirings of a timing control circuit 21, a horizontal driving circuit 22, a write scanning circuit 23, and a power supply scanning circuit 24 are extended to form external connection terminals (not shown in the figure) at this exposed region 210. An FPC (Flexible Printed Circuit) 220 for signal input/output may be provided for the external connection terminals.

### Application Example 1

FIG. 13 shows an external view of a television receiver to which the display according to the above-described embodiment and the like is applicable. This television receiver has, for example, an image display screen section 300 including a front panel 310 and a filter glass 320, and the image display screen section 300 is composed of the display according to the above-described embodiment and the like.

### Application Example 2

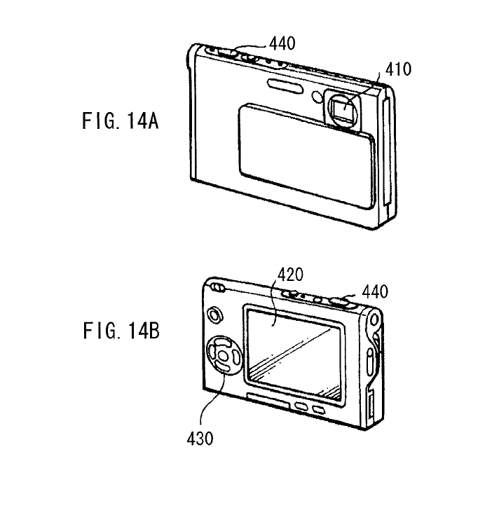

FIG. 14 shows an external view of a digital camera to which the display according to the above-described embodiment and the like is applicable. This digital camera has, for example, a light emitting section 410 for flashing, a display section 420, a menu switch 430, and a shutter button 440, and the display section 420 is composed of the display according to the above-described embodiment and the like.

### Application Example 3

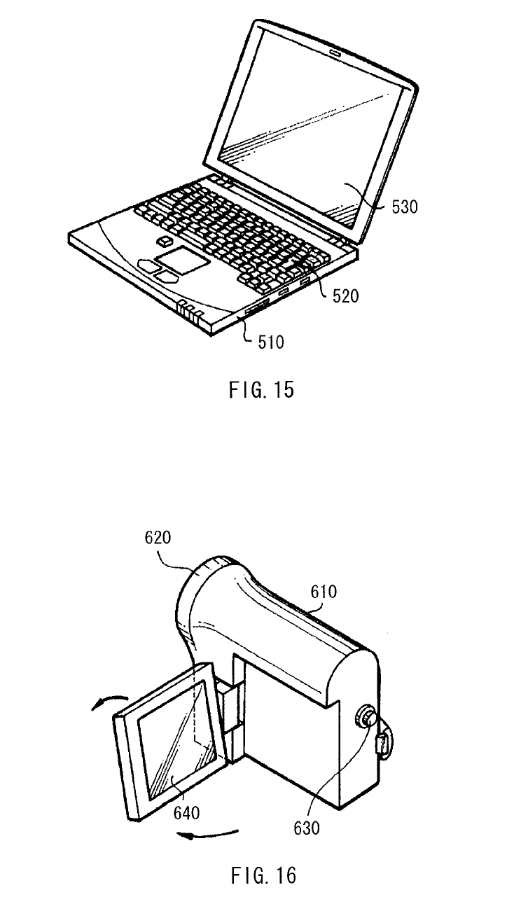

FIG. 15 shows an external view of a notebook personal computer to which the display according to the above-described embodiment and the like is applicable. This notebook personal computer has, for example, a main body 510, a keyboard 520 for operation of entering characters and the like, and a display section 530 for image display, and the display section 530 is composed of the display according to the above-described embodiment and the like.

### Application Example 4

FIG. 16 shows an external view of a video camera to which the display according to the above-described embodiment and the like is applicable. This video camera has, for example, a main body section 610, a lens 620 for shooting a subject, that is provided at the front lateral side of the main body section 610, a start/stop switch 630 at shooting time, and a display section 640, and the display section 640 is composed of the display according to the above-described embodiment and the like.

### Application Example 5

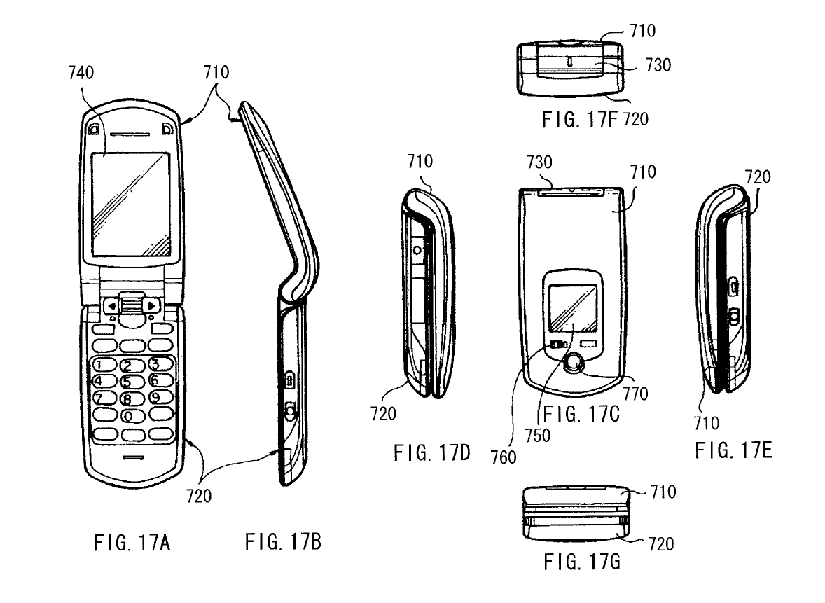

FIG. 17 shows an external view of a cellular phone to which the display according to the above-described embodiment and the like is applicable. For example, this cellular phone is configured of an upper chassis 710 and a lower chassis 720 coupled to each other with a coupling section (hinge section) 730, and has a display 740, a sub-display 750, a picture light 760, and a camera 770. The display 740 or the sub-display 750 is composed of the display according to the above-described embodiment and the like.

The present technology is described hitherto by citing the above-described embodiments and application examples, although the present technology is not limited thereto, but different modifications are available.

For example, in the above-described embodiment and the like, a case where the present technology is applied to a display is described, although the present technology is also applicable to any other devices such as a lighting unit. In case of the lighting unit, the above-described display panel is a light emitting panel.

Further, in the above-described embodiment and the like, a case where the display is an active matrix type is described, although a configuration of the pixel circuit 12 for active matrix drive is not limited to that described in the above-described embodiment and the like. Therefore, it is possible to add a capacitor device or a transistor to the pixel circuit 12 as appropriate. In this case, in addition to the timing generation circuit 21, the image signal processing circuit 22, the data line driving circuit 23, the gate line driving circuit 24, and the drain line driving circuit 25 that are described above, other necessary driving circuits may be added according to a change in the pixel circuit 12.

Furthermore, in the above-described embodiment and the like, the timing generation circuit 21 and the image signal processing circuit 22 control driving of the data line driving circuit 23, the gate line driving circuit 24, and the drain line driving circuit 25, although other circuits may carry out such a driving control alternatively. Further, control of the data line driving circuit 23, the gate line driving circuit 24, and the drain line driving circuit 25 may be performed in either hardware (circuit) or software (program).

Additionally, in the above-described embodiment and the like, it is described that the source and the drain of the writing transistor Tws as well as the source and the drain of the driving transistor Tdr are fixed, although it goes without saying that a relation in an opposed position between the source and drain may be a reverse of the above description depending on a direction of current flow.

Further, in the above-described embodiment and the like, it is described that the writing transistor Tws and the driving transistor Tdr are formed of n-channel MOS TFTs, although one or both of the writing transistor Tws and the driving transistor Tdr may be formed of p-channel MOS TFTs. It is to be noted that when the driving transistor Tdr is formed of a p-channel MOS TFT, the anode 35A of the organic EL device 11 becomes a cathode, while the cathode 35B of the organic EL device 11 becomes an anode in the above-described embodiment and the like. In addition, in the above-described embodiment and the like, the writing transistor Tws and the driving transistor Tdr are not necessarily an amorphous silicon type TFT or a micro silicon type TFT at any time, but they may be, for example, a low-temperature polysilicon type TFT. Moreover, the substrate formed with the gate is not limited to a glass substrate, and may be an insulating substrate such as a Si substrate.

Note that the present technology may also include the following configuration.

(1) A display panel including, for each pixel:
an organic EL device and a pixel circuit,
wherein the pixel circuit has a first transistor to write an image signal and a second transistor to drive the organic EL device based on the image signal written by the first transistor, the second transistor having a gate, a source, and a drain,
the organic EL device has an anode, an organic layer, and a cathode,
the gate of the second transistor is a simple structure of a transparent conductive layer, or a stacked structure of a transparent conductive layer and a metallic conductive layer, and
the anode of the organic EL device has a layer that is formed on a same layer as the transparent conductive layer and is formed of a same material as the transparent conductive layer.

(2) The display panel according to (1), wherein the anode of the organic EL device is formed on a glass substrate.

(3) A display including:
a display panel; and
a driving circuit driving each pixel,
wherein the display panel has an organic EL device and a pixel circuit for each pixel,
the pixel circuit has a first transistor to write an image signal and a second transistor to drive the organic EL device based on the image signal written by the first transistor, the second transistor having a gate, a source, and a drain,
the organic EL device has an anode, an organic layer, and a cathode,
the gate of the second transistor is a simple structure of a transparent conductive layer, or a stacked structure of a transparent conductive layer and a metallic conductive layer, and
the anode of the organic EL device has a layer that is formed on a same layer as the transparent conductive layer and is formed of a same material as the transparent conductive layer.

(4) The display panel according to (1) or (2), wherein the anode is formed collectively with the gate of the second transistor.

(5) The display panel according to any one of (1), (2) and (4), wherein an organic EL device emitting white EL light is provided.

(6) The display panel according to any one of (1), (2), (4) and (5), wherein the pixel circuit includes a holding capacitor.

(7) The display panel according to any one of (1), (2), and (4) to (6), wherein the pixel circuit has a writing transistor connected in series with the first transistor.

(8) The display panel according to any one of (1), (2), and (4) to (7), wherein the cathode of the organic EL device is connected to a ground line.

(9) The display panel according to any one of (1), (2), and (4) to (8), wherein the stacked structure is formed by stacking the transparent conductive layer and the metallic conductive layer in this order from a glass substrate side.

(10) The display panel according to any one of (1), (2), and (4) to (9), wherein the anode of the organic EL device is formed to have the same film thickness as the transparent conductive layer.

(11) The display panel according to any one of (1), (2), and (4) to (10), wherein the gate of the second transistor is formed on a glass substrate.

(12) The display according to (3), wherein the anode of the organic EL device is formed on a glass substrate.

(13) The display according to (3) or (12), wherein the anode is formed collectively with the gate of the second transistor.

(14) The display according to any one of (3), (12), and (13), wherein an organic EL device emitting white EL light is provided.

(15) The display according to any one of (3), and (12) to (14), wherein the pixel circuit includes a holding capacitor.

(16) The display according to any one of (3), and (12) to (15), wherein the pixel circuit has a writing transistor connected in series with the first transistor.

(17) The display according to any one of (3), and (12) to (16), wherein the cathode of the organic EL device is connected to a ground line.

(18) The display according to any one of (3), and (12) to (17), wherein the stacked structure is formed by stacking the transparent conductive layer and the metallic conductive layer in this order from a glass substrate.

(19) The display according to any one of (3), and (12) to (18), wherein the anode is formed to have the same film thickness as the transparent conductive layer.

(20) The display according to any one of (3), and (12) to (19), wherein the gate of the second transistor is formed on a glass substrate.

The present disclosure contains subject matter related to that disclosed in Japanese Priority Patent Application JP 2011-194958 filed in the Japan Patent Office on Sep. 7, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display panel comprising, for each pixel:
an organic EL device and a pixel circuit,
wherein the pixel circuit has a first transistor to write an image signal and a second transistor to drive the organic EL device based on the image signal written by the first transistor, the second transistor having a gate, a source, and a drain,
the organic EL device has an anode, an organic layer, and a cathode,
the gate of the second transistor is a simple structure of a transparent conductive layer, or a stacked structure of a transparent conductive layer and a metallic conductive layer, and
the anode of the organic EL device has a layer that is formed on a same layer as the transparent conductive layer and is formed of a same material as the transparent conductive layer.

2. The display panel according to claim 1, wherein the anode of the organic EL device is formed on a glass substrate.

3. A display comprising:
a display panel; and
a driving circuit driving each pixel,
wherein the display panel has an organic EL device and a pixel circuit for each pixel,
the pixel circuit has a first transistor to write an image signal and a second transistor to drive the organic EL device based on the image signal written by the first transistor, the second transistor having a gate, a source, and a drain,
the organic EL device has an anode, an organic layer, and a cathode,
the gate of the second transistor is a simple structure of a transparent conductive layer, or a stacked structure of a transparent conductive layer and a metallic conductive layer, and
the anode of the organic EL device has a layer that is formed on a same layer as the transparent conductive layer and is formed of a same material as the transparent conductive layer.

4. The display panel according to claim 1, wherein the anode is formed collectively with the gate of the second transistor.

5. The display panel according to claim 1, wherein an organic EL device emitting white EL light is provided.

6. The display panel according to claim 1, wherein the pixel circuit includes a holding capacitor.

7. The display panel according to claim 1, wherein the pixel circuit has a writing transistor connected in series with the first transistor.

8. The display panel according to claim 1, wherein the cathode of the organic EL device is connected to a ground line.

9. The display panel according to claim 1, wherein the stacked structure is formed by stacking the transparent conductive layer and the metallic conductive layer in this order from a glass substrate side.

10. The display panel according to claim 1, wherein the anode of the organic EL device is formed to have the same film thickness as the transparent conductive layer.

11. The display panel according to claim 1, wherein the gate of the second transistor is formed on a glass substrate.

12. The display according to claim 3, wherein the anode of the organic EL device is formed on a glass substrate.

13. The display according to claim 3, wherein the anode of the second transistor is formed collectively with the gate of the second transistor.

14. The display according to claim 3, wherein an organic EL device emitting white EL light is provided.

15. The display according to claim 3, wherein the pixel circuit includes a holding capacitor.

16. The display according to claim 3, wherein the pixel circuit has a writing transistor connected in series with the first transistor.

17. The display according to claim 3, wherein the cathode of the organic EL device is connected to a ground line.

18. The display according to claim 3, wherein the stacked structure is formed by stacking the transparent conductive layer and the metallic conductive layer in this order from a glass substrate.

19. The display according to claim 3, wherein the anode is formed to have the same film thickness as the transparent conductive layer.

20. The display according to claim 3, wherein the gate of the second transistor is formed on a glass substrate.
